(19) United States
(12) Patent Application Publication
(10) Pub. No.: US 2002/0121389 A1
(43) Pub. Date: Sep. 5, 2002

(54) Non-continuous connecting web for cable applications

(75) Inventors: David M. Price, Charlotte, NC (US); Joseph S. Elko, Hickory, NC (US); Ricky D. Rathbone, Catawba, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: CommScope Properties, LLC

(21) Appl. No.: 10/081,117

(22) Filed: Feb. 22, 2002

Related U.S. Application Data
(60) Provisional application No. 60/270,933, filed on Feb. 23, 2001.

(51) Int. Cl. H01B 11/02

(52) U.S. Cl. 174/113 R

(57) ABSTRACT

The present invention is a non-continuous connecting web for side-by-side elongate cables that eliminates the need to use slitting tools or to remove the connecting web when the cables are connectorized or fitted to a bulkhead grommet. In particular, the connecting web includes intermittent gaps and the cables can be severed within the intermittent gaps to allow the cables to be attached to a connector or to a bulkhead grommet. The present invention also includes methods of connecting cables using the non-continuous connecting web of the invention and methods of producing a communications cable include the non-continuous connecting web of the invention.

### CROSS-REFERENCE TO RELATED APPLICATIONS

This application is related to commonly owned copending provisional application Serial No. 60/270,933, filed Feb. 23, 2002, and claims the benefit of the earlier filing date of this application under 35 U.S.C. § 119(e).

### FIELD OF THE INVENTION

The present invention relates to connecting webs for cable applications and more particularly, to non-continuous connecting webs for connecting side-by-side cables that allow the side-by-side cables to be easily connectorized or fitted to a bulkhead grommet.

### BACKGROUND OF THE INVENTION

Coaxial cables are widely used in many different applications such as the distribution of video signals. In most situations, a single coaxial cable is sufficient to carry the necessary signals. However, there are many other applications where multiple cables are needed and the cable manufacturing industry has provided various types of multiple cable assemblies to meet these needs.

For example, coaxial cable may be provided with an attached support wire or messenger wire. Often, the messenger wire is positioned adjacent to and parallel with the coaxial cable with both cables being encased in thermoplastic insulating coatings. The two insulated cables are connected together by a web of the same thermoplastic insulating material forming an integral side-by-side coaxial cable and messenger wire support.

In other applications, pairs or triples of coaxial cable may be desired for redundancy or to increase signal carrying capacity. Multiple cable designs may also have twisted pair or multi-strand control wires placed adjacent to coaxial cables. Messenger wire supports may be added to these dual and triple cable designs. In each of these designs, the cables are held in a side-by-side relationship by a web usually formed out of the same material used to provide the outer cable insulation layer. To use such cables, the web must be severed for some distance back from the end of the cable to free the cable for connection to an end point. Often, the web is designed to be quite weak, allowing the adjacent cables to be pulled apart. However, this technique can result in damaging the insulating coating on one or more of the cables. In addition, the web material is not completely removed from one or more of the cables.

A slitting tool can alternatively be used to separate the web between the cables. However, it is difficult to fully remove the web and a ridge of excess web material can remain on the cable. For coaxial cables, in particular, this ridge can interfere with proper attachment of an electrical connector. Coaxial connectors are usually designed for use with coaxial cables having a circular defect-free cross section. The excess web material left with prior slitting techniques produces a protrusion on the cross section that may prevent the cable from properly seating completely in the connector or a bulkhead grommet. Alternatively, the ridge may prevent the connector sleeve from properly sealing around the cable when the connector is crimped. In addition, the ridge of excess web material often provides a migration path for water, which can result in corrosion of the cable.

One solution to this problem has been to improve slitting tool technology such as is described in U.S. Pat. No. 6,131,289 to limit the existence of residue. However, there is a need in the art to provide a method of separating cables that does not require a slitting tool. Another solution to the problem has been to provide a web that remains on only one of the side-by-side cables. However, the connectorization and grommet fitting issues still exist with respect to the other side-by-side cable.

### SUMMARY OF THE INVENTION

The present invention provides a non-continuous connecting web for side-by-side cables that eliminates the need to use slitting tools or to remove the connecting web when the cables are connectorized or fitted to a bulkhead grommet. In particular, the connecting web of the invention includes intermittent gaps and the cables can be severed within the intermittent gaps to allow the cables to be attached to a connector or to a bulkhead grommet.

The communications cable of the present invention includes a first elongate cable, a second elongate cable in parallel spaced apart relation from the first elongate cable and a non-continuous connecting web between the first elongate cable and the second elongate cable and connected to the first elongate cable and the second elongate cable. The connecting web has a longitudinal axis parallel to the first elongate cable and the second elongate cable and includes a plurality of intermittent gaps in the direction of the longitudinal axis to allow at least one of the first elongate cable and the second elongate cable to be connectorized without removing the connecting web. The connecting web connects to the first elongate cable along a first surface and to the second elongate cable along a second surface and the connecting web preferably has a substantially constant lateral cross-sectional area from the first surface to the second surface. The connecting web preferably has a width of at least 0.05 inches and preferably includes a plurality of web sections having a length of from about 6 inches to about 24 feet and intermittent gaps having a length of at least about 1 inch and typically from about 1 inch to about 3 feet. The communications cable can include more than two elongate cables, each elongate cable connected to at least one other elongate cable through the use of the connecting web. Typically, the first elongate cable and the second elongate cable each include one or more cables selected from the group consisting of coaxial cables, fiber optic cables, twisted pair cables, electrical cables and support cables. Preferably, at least one of the first elongate cable and the second elongate cable is a coaxial cable and the other of the first elongate cable and the second elongate cable can include two twisted pairs cables. At least one of the first elongate cable and the second elongate cable can include one or more cables within a cable jacket and the connecting web can be attached to the cable jacket.

In one embodiment, the invention comprises a method of preparing a communications cable for connectorization. According to this method, a communications cable is provided comprising a first elongate cable, a second elongate cable in parallel spaced apart relation from the first elongate cable, and a non-continuous connecting web between the first elongate cable and the second elongate cable and connected to the first elongate cable and the second elongate cable, the connecting web having a longitudinal axis parallel to the first elongate cable and the second elongate cable and comprising a plurality of intermittent gaps in the direction of the longitudinal axis. The first elongate cable and the second elongate cable are then severed within an intermittent gap in the connecting web. At least one of the elongate cables can then be connected to another cable.

In another embodiment, the present invention comprises a method of preparing a communications cable. In this embodiment, two or more cables in parallel spaced apart relation in a side-by-side relationship are advanced through an extruder mounted crosshead. A polymer melt is extruded over the advancing cables and the advancing cables are passed through a die to form the polymer melt into a predetermined shape for the connecting web. The intermittent gaps can then be formed in the connecting web and the connecting web allowed to cool to form the non-continuous connecting web.

These and other features and advantages of the present invention will become more readily apparent to those skilled in the art upon consideration of the following detailed description and accompanying drawing, which describe both the preferred and alternative embodiments of the present invention.

### BRIEF DESCRIPTION OF THE DRAWINGS

FIG. 1 is a perspective view of a communications cable according to a preferred embodiment of the invention wherein a non-continuous connecting web having intermittent gaps is used to connect side-by-side cables.

### DETAILED DESCRIPTION OF THE PREFERRED EMBODIMENTS

In the drawings and the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description and accompanying drawings. In the drawings, like numbers refer to like elements throughout.

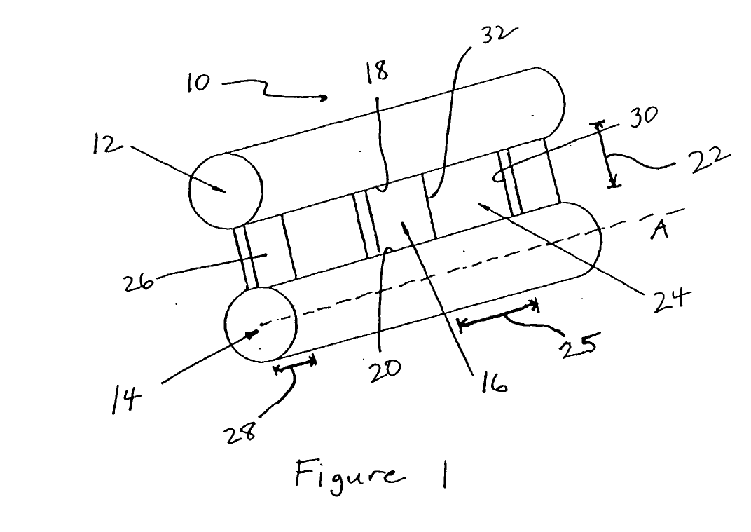

FIG. 1 illustrates a communications cable 10 according to a preferred embodiment of the invention. The communications cable 10 can include a plurality of elongate cables. For example, FIG. 1 includes a first elongate cable 12 and a second elongate cable 14. The elongate cables 12 and 14 extend longitudinally along a longitudinal axis (as illustrated by line A in cable 14) that extends along the length of the cable. Although FIG. 1 illustrates the use of two cables, any configuration of two or more cables can be used in accordance with the invention.

As shown in FIG. 1, adjacent cables (e.g. cables 12 and 14) are in parallel spaced apart relation in a side-by-side relationship. The elongate cables 12 and 14 can represent either a single cable (e.g. a coaxial cable) or can include a plurality of cables provided within a cable jacket. The elongate cables can be coaxial cables, fiber optic cables, twisted pair cables, electrical cables, support or messenger cables, and the like. Suitable cables are described, for example, in coassigned U.S. Pat. Nos. 6,139,957; 6,137,058; 6,064,008; 6,037,545; 5,969,295; 5,959,245; 5,949,018; 5,926,949; 5,814,768; 5,777,271; 5,719,353; 5,651,081; 5,614,319; 5,560,536; 5,542,020; 5,469,523; 5,462,803; 5,448,670; 5,345,526; 5,293,678; 5,254,188; 5,042,904; 4,894,488; 4,701,575; 4,691,081; 4,515,992; 4,484,023; 4,472,595; 4,107,354; and 4,104,481, and coassigned pending U.S. patent application Ser. Nos. 09/019,417; 09/070,789; 09/326,049; 09/485,656; 09/552,903; 09/577,997; 09/598,508; 09/603,818; and 09/939,956, all of which are hereby incorporated by reference in their entirety. In one preferred embodiment of the invention, the first elongate cable is a coaxial cable (e.g. a drop cable) and the second elongate cable includes two twisted pair cables.

In accordance with the invention, adjacent cables (e.g. cables 12 and 14) are attached to one another through the use of a non-continuous connecting web 16. In particular, as shown in FIG. 1, the connecting web 16 connects to cable 12 along a first surface 18 and to cable 14 along a second surface 20. The connecting web 16 can be formed of any suitable thermoplastic material including but not limited to linear low density polyethylene (LLDPE), medium density polyethylene (MDPE), high density polyethylene (HDPE), low density polyethylene (LDPE), polyvinyl chloride (PVC), and mixtures thereof. Preferably, the connecting web 16 is formed of the same material that is used to form the cable jacket(s) for the side-by-side cables. The connecting web 16 preferably has a width 22 of at least 0.05 inches and more preferably from about 0.06 to about 0.5 inches. For example, for drop cable, the width 22 is preferably from about 0.06 inches to about 0.09 inches.

The connecting web 16 preferably has a substantially constant thickness (or lateral cross-sectional area) from the first surface 18 to the second surface 20. In particular, the connecting web preferably has a thickness of greater than 0.025 inches, and more preferably from about 0.03 to about 0.1 inches. For example, for drop cable, the thickness 23 is preferably from about 0.03 to about 0.035 inches.

The non-continuous connecting web 16 includes a plurality of intermittent gaps 24. The gaps 24 provide locations wherein the cables can be connectorized without the need to remove the connecting web 16. The gaps 24 typically have a length 25 sufficient to allow a connector or bulkhead grommet to connect to the cables without a need to remove the connecting web 16. Preferably, the gaps 24 have a length 25 of at least about 1 inch preferably from about 1 inch to about 3 feet and typically from about 1 inch to about 5 inches. The non-continuous connecting web 16 also includes a plurality of web sections 26 between the gaps 24. The web sections preferably have a length 28 from about 6 inches to about 24 feet and typically from about 3 feet to about 10 feet.

The communications cable 10 can be manufactured by advancing two or more cables (e.g. 12 and 14) in parallel spaced apart relation in a side-by-side relationship through an extruder mounted crosshead. The thermoplastic materials listed above for use as the connecting web material are fed to the extruder and heated to form a polymer melt. As the cables are advanced through the crosshead, the polymer melt is extruded over the cables. A die is used to form the polymer melt into the predetermined shape for the connecting web 16 as the cables 12 and 14 pass through the crosshead. The gaps 24 can then be produced in the connecting web 16. Once the gaps 24 have been formed in the web, the web is allowed to cool to form the non-continuous web 16 of the invention.

One method of producing the gaps 24 in the connecting web 16 is to push a cutting tool that includes a blade in and out between the cables 12 and 14 along the first surface 18 and the second surface 20 to remove the web material. For example, the cutting tool can include two blades that travel along the surfaces connecting the web to the cables, and a scoop the collects the web material being removed and that severs the web material from the communications cable at the front end 30 and the back end 32 of the gap 24. The cutting tool can be hollow or flat and is preferably attached to a cam and motor. The cam and motor can communicate with a closed loop system connected to the overall processing system so that the width of the gaps 24 can be maintained at varying line speeds.

An alternative method of producing gaps 24 in the web is to use compressed air to blow out the material between the joining cables. The air flow can be controlled with an air solenoid system at a predetermined psi. As with the cam and motor used with the cutting tool, the compressed air system can communicate with a closed loop system connected to the overall processing system so that the width of the gaps 24 can be maintained at varying line speeds.

The present invention provides a non-continuous connecting web 16 for side-by-side cables (e.g. 12 and 14) that does not have to be removed for the cables to be attached to connectors or to bulkhead grommets. Thus, the connecting web eliminates the need for slitting tools and the need to pull at the connecting web or the cables themselves. In accordance with the invention, the side-by-side cables can be connectorized or fitted to a bulkhead grommet by severing the cables within an intermittent gap 24 in the connecting web 16. Any tool or device typically used to cut cable can be used to sever the cables within the intermittent gap 24 and such tools and devices are well known to those skilled in the art. Because no connecting web is provided in the intermittent gaps 24 where the cables are connected to other cables or to bulkhead grommets, the issues of removing the connecting web that are common in the art such as the presence of residue on the cables after removal of the connecting web do not exist when the communications cable 10 of the invention is used. The non-continuous connecting web 16 of the present invention facilitates good connectorization between the side-by-side cables and other cables and a good fit to a bulkhead grommet.

It is understood that upon reading the above description of the present invention and reviewing the accompanying drawings, one skilled in the art could make changes and variations therefrom. These changes and variations are included in the spirit and scope of the following appended claims.

That which is claimed:

1. A communications cable, comprising:
a first elongate cable;
a second elongate cable in parallel spaced apart relation from said first elongate cable; and
a non-continuous connecting web between said first elongate cable and said second elongate cable and connected to said first elongate cable and said second elongate cable, said connecting web having a longitudinal axis parallel to said first elongate cable and said second elongate cable and comprising a plurality of intermittent gaps in the direction of said longitudinal axis to allow at least one of the first elongate cable and the second elongate cable to be connectorized without removing said connecting web.

2. The communications cable according to claim 1, wherein the connecting web connects to said first elongate cable along a first surface and to said second elongate cable along a second surface and wherein said connecting web has a substantially constant lateral cross-sectional area from said first surface to said second surface.

3. The communications cable according to claim 1, wherein the connecting web has a width of at least 0.05 inches.

4. The communications cable according to claim 1, wherein the connecting web has a plurality of web sections having a length of from about 6 inches to about 24 feet.

5. The communications cable according to claim 1, wherein the intermittent gaps have a length of from about 1 inch to about 3 feet.

6. The communications cable according to claim 1, comprising more than two elongate cables, each elongate cable connected to at least one other elongate cable through the use of said connecting web.

7. The communications cable according to claim 1, wherein the first elongate cable and the second elongate cable each include one or more cables selected from the group consisting of coaxial cables, fiber optic cables, twisted pair cables, electrical cables and support cables.

8. The communications cable according to claim 1, wherein at least one of said first elongate cable and said second elongate cable is a coaxial cable.

9. The communications cable according to claim 8, wherein the other of said first elongate cable and said second elongate cable includes two twisted pairs cables.

10. The communications cable according to claim 1, wherein at least one of said first elongate cable and second elongate cable includes one or more cables within a cable jacket and the connecting web is attached to said cable jacket.

11. A method of preparing a communications cable for connectorization, comprising the steps of:
providing a communications cable comprising a first elongate cable, a second elongate cable in parallel spaced apart relation from said first elongate cable, and a non-continuous connecting web between said first elongate cable and said second elongate cable and connected to said first elongate cable and said second elongate cable, said connecting web having a longitudinal axis parallel to said first elongate cable and said second elongate cable and comprising a plurality of intermittent gaps in the direction of said longitudinal axis; and
severing said first elongate cable and said second elongate cable within an intermittent gap in the connecting web; and
connecting at least one of the first elongate cable and the second elongate cable to another cable.

12. A method of preparing a communications cable, comprising the steps of:
advancing two or more cables in parallel spaced apart relation in a side-by-side relationship through an extruder mounted crosshead;
extruding a polymer melt over the advancing cables;
passing the advancing cables through a die to form the polymer melt into a predetermined shape for the connecting web; and
forming intermittent gaps in the connecting web and allowing the polymer melt to cool to form the non-continuous connecting web.
